(19) United States
(12) Patent Application Publication
(10) Pub. No.: US 2012/0194688 A1
(43) Pub. Date: Aug. 2, 2012

(54) TRANSMITTER, RECEIVER AND THEIR CONFIGURATION SYSTEM USED FOR FLASH DEVICE WIRELESS MULTI-ZONE INDEPENDENT CONTROL

(75) Inventors: YuanGul LI, ShenZhen (CN); ChangChun YIN, ShenZhen (CN)

(73) Assignee: Phottix (HK) Ltd., Hong Kong (CN)

(21) Appl. No.: 13/278,482

(22) Filed: Oct. 21, 2011

(30) Foreign Application Priority Data
Jan. 30, 2011 (CN) 201120033126.0

(51) Int. Cl. H04N 5/232

(52) U.S. Cl. 348/211.2; 348/E05.043

(57) ABSTRACT

A transmitter used for wireless multi-zone independent control of flash devices is disclosed. The transmitter includes a zone signal transmitting unit at a transmitter terminal connected to a micro processing unit. The zone signal transmission unit at the transmitter terminal is connected with a zone selection unit at the transmitter terminal with multiple independent switch devices and a zone display unit at the transmitter terminal connected to the transmitter terminal. A corresponding receiver, and a system consisting of said transmitter and multiple receivers, are also disclosed.

### CROSS-REFERENCE TO RELATED APPLICATION

This U.S. patent application claims priority to Chinese Patent Application No. 201120033126.0, filed Jan. 30, 2011, which is incorporated by reference herein in its entirety.

### FIELD OF THE INVENTION

The present invention relates generally to fittings used for cameras, and more specifically, to a system of flash device wireless multi-zone independent control used for camera. The system includes a transmitter and at least one receiver.

### BACKGROUND OF THE INVENTION

In generic use, when wirelessly controlling flashing or non-flashing of multiple external flash devices, a camera usually realizes synchronous flashing through changing the channels of transmitter and receiver or controls zone synchronous flashing through single switch circle operation. This has made transmitter operation complicated and inflexible, and the indication is not visualized enough.

### SUMMARY OF THE INVENTION

To the above technical problems, aspects of the present invention are directed to providing a transmitter with wireless multi-zone independent control of flash devices used for the camera. The transmitter can individually select the receiver assigned to a zone or multi-zone, which has improved the flexibility of transmitter control. It uses an LED or LCD display to make operation more visualized.

According to an exemplary embodiment of the present invention, the transmitter used for wireless multi-zone independent control of flash devices includes a microprocessing unit at a transmitter terminal, a test switch unit, an LED display unit, a focus and photographing control unit, a channel selection unit, a camera input unit and a wireless output unit at the transmitter terminal connected to the microprocessing unit as well as a camera output unit connected to a camera input unit. The transmitter also includes a zone signal transmitting unit at the transmitter terminal connected to the micro processing unit. The zone signal transmitting unit at the transmitter terminal is connected with a zone selection unit at the transmitter terminal with multiple independent switch devices and a zone display unit at the transmitter terminal connected to the zone selection unit at the transmitter terminal.

Preferably, the zone switch unit at the transmitter terminal includes multiple independent switches which transmit unit input control signals to the zone signal transmitting unit at the transmitter terminal. According to these control signals, the zone signal transmitting unit at the transmitter terminal drives the zone display unit at the transmitter terminal to indicate the selected zone and at the same time transmits the indicated zone information to the microprocessing unit which will output the corresponding one group or multiple groups of control codes through the wireless output unit.

For the transmitter used for wireless multi-zone independent control of flash devices, aspects of the present invention are also directed to providing a receiver for the transmitter used for wireless multi-zone independent control of flash devices. According to an exemplary embodiment, the receiver includes a microprocessing unit at the receiver terminal, a test switch unit, an LED display unit, a focus and photographing output unit, a channel selection unit, an output unit and a wireless input unit at the receiver terminal connected to the micro processing unit as well as a focus and photographing switch control unit connected to the focus and photographing output unit at the receiver terminal. The receiver also includes a zone selection unit at the receiver terminal connected to the micro processing unit.

Preferably, the zone selection unit at the receiver terminal includes one multi-gear selection switch device such as a multi-gear toggle switch used to control the receiver's only receiving fixed control code.

According to aspects of the present invention, when a camera uses multiple external flash devices at the same time and the receiver remains unchanged, a user can selectively control the flashing of single or multiple flash devices using the above-described transmitter and receiver. The status indication method in such a zone can be realized through a hardware display or a software display such as an LED indicator light and an LCD screen. This makes the user's operation more visualized and flexible.

According to one aspect of the present invention, a transmitter for wireless multi-zone independent control of a flash device for a camera is disclosed. The transmitter includes a microprocessor, a zone selector, a zone display, and a zone signal transmitter. The zone selector is configured to receive a zone selection from a user. The zone display is configured to indicate the zone selection to the user. The zone signal transmitter is in communication with the zone selector. The zone signal transmitter is configured to receive the zone selection from the zone selector and transmit the zone selection (i) to the zone display for indicating the zone selection to the user, and (ii) to the microprocessor for wireless transmission to a receiver.

According to another aspect of the present invention, a system for wireless multi-zone independent control of a flash device for a camera is disclosed. The system includes a transmitter as described above, and at least one receiver. The receiver is configured to receive the wireless transmission from the transmitter. The receiver includes a zone selector including a switch. The zone selector is configured to receive a zone selection from a user via the switch.

According to yet another aspect of the present invention, a receiver for wireless multi-zone independent control of a flash device for a camera is disclosed. The receiver includes a microprocessor and a zone selector. The zone selector includes a switch. The zone selector is configured to receive a zone selection from a user via the switch. The zone selector is configured to transmit the zone selection to the microprocessor.

According to still another aspect of the present invention, a transmitter used for flash device wireless multi-zone independent control is disclosed. The transmitter includes a microprocessing unit at a transmitter terminal, a test switch unit, an LED display unit, a focus and photographing control unit, a channel selection unit, a camera input unit and a wireless output unit at the transmitter terminal connected to the microprocessing unit as well as a camera output unit connected to the camera input unit. The transmitter also includes a zone signal transmitting unit at the transmitter terminal connected to the microprocessing unit, wherein the zone signal transmitting unit at the transmitter terminal is connected with a zone selection unit at the transmitter terminal with multiple independent switch devices and a zone display unit at the transmitter terminal connected to the transmitter terminal.

### BRIEF DESCRIPTION OF THE DRAWINGS

FIG. 1 is a functional block diagram of an exemplary embodiment of a transmitter in accordance with aspects of the present invention;

FIG. 2 is a functional block diagram of an exemplary embodiment of a receiver in accordance with aspects of the present invention;

FIG. 3 is a schematic diagram of an exemplary embodiment of a zone switch unit of the transmitter of FIG. 1;

FIG. 4 is a structure diagram of the receiver of FIG. 2;

FIG. 5 is a structure diagram of the transmitter of FIG. 1; and

FIG. 6 is a block diagram of an exemplary system for wireless multi-zone independent control of a flash device for a camera in accordance with aspects of the present invention.

### DETAILED DESCRIPTION OF THE INVENTION

A detailed explanation for aspects of the present invention is given below with reference to the Figures and typical examples.

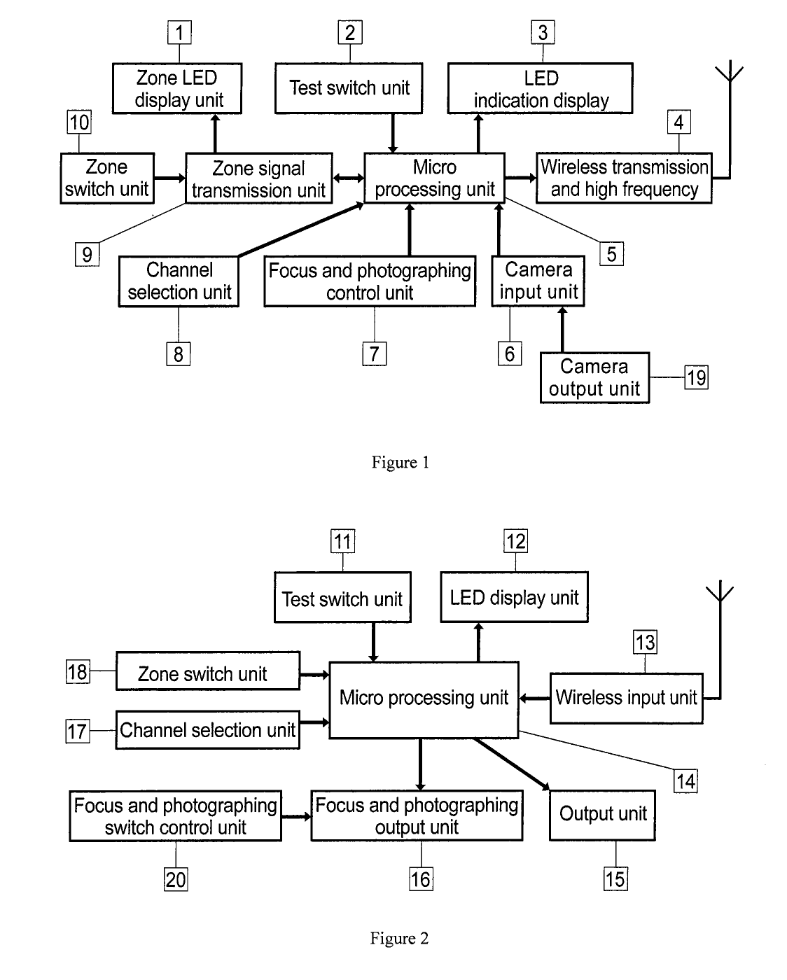

Referring to FIG. 1, a transmitter includes microprocessing unit 5, test switch unit 2 connected to microprocessing unit 5, LED display unit 3, channel selection unit 8, focus and photographing control unit 7, camera input unit 6 and wireless output unit 4 at the transmitter terminal. Camera input unit 6 is connected with camera output unit 19 to receive data from an associated camera, to which the transmitter is connected. The operation of the aforementioned elements will be understood by one of ordinary skill in the art from the description herein.

The transmitter further includes a zone signal transmitting unit 9, zone switch unit 10 and zone display unit 1 at the transmitter terminal. The selection and control of zones using the transmitter may be implemented by zone signal transmitting unit 9 at the transmitter terminal connected to microprocessing unit 5 at the transmitter terminal, zone switch unit 10 at the transmitter terminal connected to zone signal transmitting unit 9, and zone display unit 1 at the transmitter terminal, such as an LED display unit or an LCD display unit.

In an exemplary embodiment, zone switch unit 10 at the transmitter terminal can include multiple independent switches which input control signals to zone signal transmitting unit 9 at the transmitter terminal. According to these control signals, zone signal transmitting unit 9 at the transmitter terminal drives zone display unit 1 at the transmitter terminal to indicate the selected zone, and at the same time, transmits the indicated zone information to microprocessing unit 5, which then outputs the corresponding one group or multiple groups of control codes through wireless output unit 4.

Referring to FIG. 2, a receiver includes microprocessing unit 14 at the receiver terminal, test switch unit 11 connected to microprocessing unit at the receiver terminal, LED display unit 12, focus and channel selection unit 17, photographing control unit 16, output unit 15 and wireless input unit 13 at the receiver terminal, as well as zone selection unit 18 at the receiver terminal connected to microprocessing unit 14 at the receiver terminal used for zone control of the receiver.

In an exemplary embodiment, zone selection unit 18 at receiver terminal can include a switch that enables a user to select which control signals sent by zone signal transmitting unit 9 are read by the receiver. When microprocessing unit 5 outputs the corresponding one group or multiple groups of control codes through wireless output unit 4, they are received at wireless input unit 13 and sent to zone selection unit 18 to determine whether they match the group of the receiver.

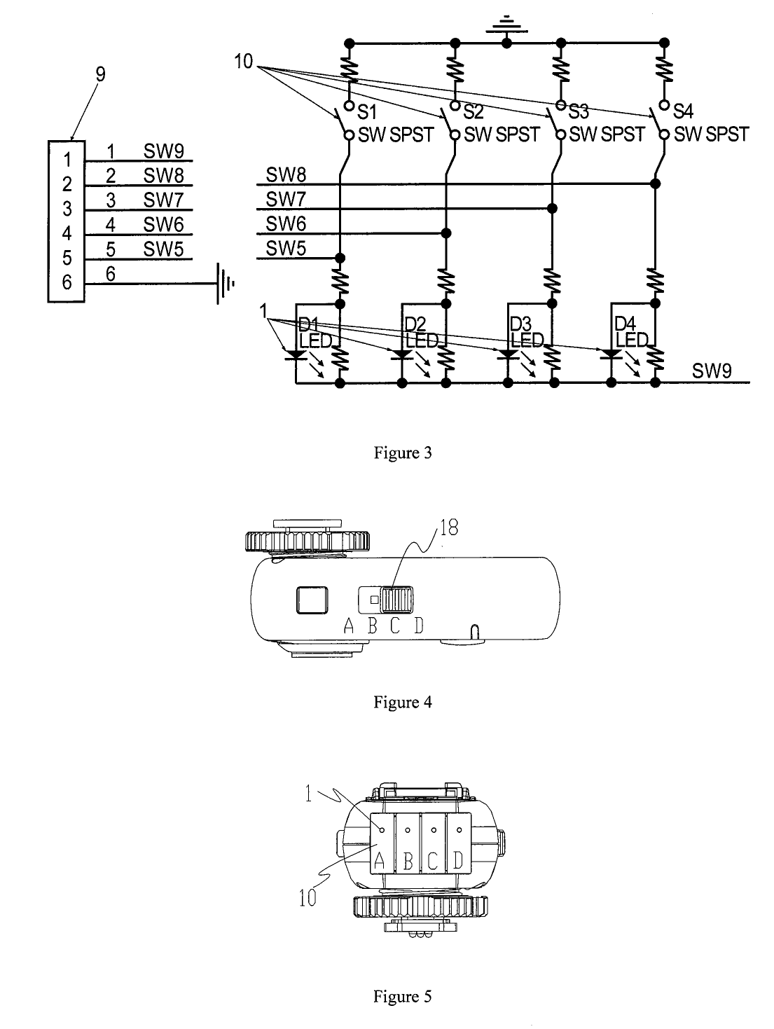

Referring to FIG. 3, the zone switch unit 10 of the transmitter can be carried out as follows: adopting a timing scan to access switches S1-S4, which may be, for example, touch switches, self-lock switches, inductive switches, or toggle switches. The transmitter includes 4 independent LEDs to indicate the status of output zone selection. The principle is as follows: whether the key accessed by microprocessor every 10 milliseconds is pressed or not. In an exemplary operation, when scanning the keys, microprocessor sets SW9 as a high level and SW5-SW8 serve as input ports. At this moment, if no switch is pressed, SW5-SW8 will be at high levels. If any of S1-S4 is pressed, SW5-SW8 will be at low levels. This operation may take approximately 10 microseconds. Then, microprocessing unit 5 may transfer SW5-SW8 as output ports and SW9 outputs at a low level in order for the LED displays in zone display unit 1 to show the independent selection zone.

For example: If A is selected as synchronous flashing zone, SW5 will output a high level and D1 will be ON. If A zone does not synchronously flash, SW5 will output a low level and D1 will be OFF. In the circuit, ON/OFF of D1-D4 can be displayed independently through scan switches S1-S4 after being processed by CPU. Similarly, any number of single control S1-Sn (n=>∞) switches and D1-Dn (n=>∞) indicator lights can be set depending on the desired number of groups. S1-S4 can be combined as various forms, such as S1, S1S2, S2S3S4 and S1S2S3S4 etc. If D1 and D2 or more indications are required to be ON, one presses the control switch S1 and S2 for D1 and D2 etc. After it is ON, the transmitter will be under the set frequency band and only sends the wireless control signal such as control code through the wireless output unit from the groups opened by S1-S4 in zone selection unit.

The receiver principle is as follows: the zone selection unit 18 at receiver terminal can be a switch or specifically a toggle switch which has the corresponding gears with the same grouping key quantity as transmitter. For example, as shown in FIGS. 4, A, B, C and D gears correspond to S1-S4 in the transmitter. The receiver can be used to select both the channel and the flashing group for an associated flash device. For example, the frequency band of the receiver can be selected using channel selection unit 17 through pressing toggle switch or code switch. Also, the zone selection unit 18 determines the synchronous flashing grouping for the receiver. For example, if it is set as gear A, it will correspond to the grouping set by S1 of transmitter. If it is set as gear B, it will correspond to the grouping set by S2 of transmitter. In this way, wireless input unit 13 of receiver only receives the wireless signal with the desired frequency (channel) and group (control code) and controls output unit 15 according to the said wireless signal.

In this way, any synchronous flashing grouping for receiver can be set through the proper setting of channel selection unit and zone selection unit.

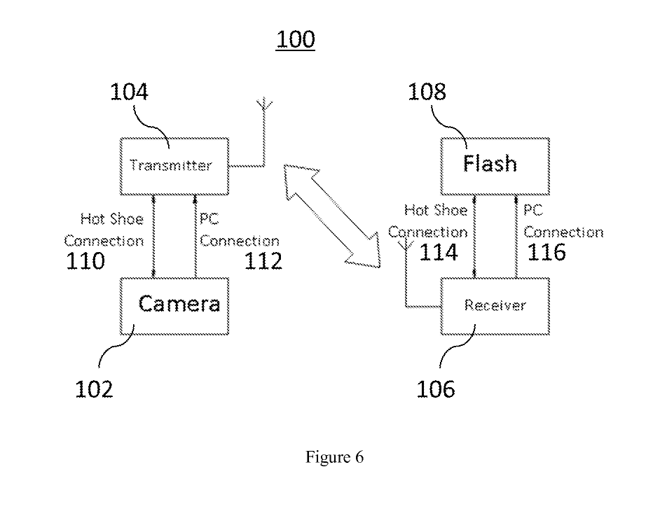

Referring to FIG. 6, an exemplary system for wireless multi-zone independent control of a flash device for a camera is disclosed in accordance with aspects of the present invention. The system 100 includes a camera 102, a transmitter 104, a receiver 106, and a flash 108. In an exemplary embodiment, the transmitter 104 corresponds to the transmitter embodiment described above with respect to FIG. 1, and the receiver 106 corresponds to the receiver embodiment described above with respect to FIG. 2. Although only one transmitter 104 and one receiver 106 are shown, multiple transmitters and/or receivers are optionally included in the system 100.

During operation of the system 100, the zone signal transmitting unit of the transmitter 104 transmits the selected zone information to a microprocessing unit of the transmitter 104, which then outputs the corresponding one group or multiple groups of control codes through the wireless output unit. The control codes are wirelessly transmitted to the receiver 106 (shown in FIG. 6 by the arrow). When the one group or multiple groups of control codes are received at the wireless input unit of the receiver 106, they are transmitted to a zone selection unit to determine whether they match the group of the receiver 106. If so, the receiver 106 uses the data transmitted from the transmitter 104 to control the flashing of the flash device 108.

In the embodiment illustrated in FIG. 6, the camera 102 is coupled directly or indirectly to the transmitter 104 via a hot shoe connection 110 and/or a PC connection 112. Alternatively, wireless or other coupling is used to facilitate communication between camera 102 and transmitter 104. Similarly, the receiver 106 is coupled directly or indirectly to the flash 108 via a hot shoe connection 114 and/or a PC connection 116, or wireless or other coupling is optionally used for this communication. The system 100 has 4 groups: A, B, C, and D, as well as 4 channels: 1, 2, 3, and 4. Receivers such as receiver 106 can be assigned both group and channel designations. The transmitter 104 will fire groups A, B, C or D, or any combination on the same channel: 1, 2, 3 or 4. Any flashes or strobes connected to system receivers 106 that are set to the same group(s) and channel as the transmitter 104 will fire.

The following procedures can be used to set groups on the transmitter 104, set channels on the transmitter 104, set groups on the receiver 106, and set channels on the receiver 106.

Setting Groups on the Transmitter
1. The system 100 has 4 groups: A, B, C and D.
2. Pressing selection buttons on the transmitter 104 allows one to select which groups will be triggered. Selected groups on the transmitter 104 will trigger receiver(s) 106 assigned that group and channel.

Setting Channels on the Transmitter
1. The system transmitter 104 has 4 transmission channels.
2. A user can move a switch on the transmitter 104 to 1, 2, 3, or 4 to select a channel.
3. The user will ensure that the system transmitters 104 and receivers 106 are set to the same channel.

Setting Groups on the Receiver
1. The system receiver 106 has four group settings.
2. A user can move a selection switch on the receiver 106 to A, B, C or D to select a group for each receiver 106.

Setting Channels on the Receiver
1. The system receiver 106 has 4 transmission channels.
2. A user can move a channel selector switch on the receiver 106 to 1, 2, 3, or 4 to select a channel.
3. The user will ensure that the system transmitters 104 and receivers 106 are set to the same channel.

Although the invention is illustrated and described herein with reference to specific embodiments, the invention is not intended to be limited to the details shown. Rather, various modifications may be made in the details within the scope and range of equivalents of the claims and without departing from the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A transmitter for wireless multi-zone independent control of a flash device for a camera, the transmitter comprising:
a microprocessor:
a zone selector configured to receive a zone selection from a user;
a zone display configured to indicate the zone selection to the user; and
a zone signal transmitter in communication with the zone selector, the zone signal transmitter configured to receive the zone selection from the zone selector and transmit the zone selection (i) to the zone display for indicating the zone selection to the user, and (ii) to the microprocessor for wireless transmission to a receiver.

2. The transmitter of claim 1, further comprising a zone switch configured to transmit unit input control signals to the zone signal transmitter, the control signals comprising instructions to the microprocessor to wirelessly transmit using one or more control codes corresponding to the zone selection.

3. The transmitter of claim 1, further comprising a plurality of switches coupled to the zone selector, the switches being selected from the group consisting of touch switches, self-lock switches, inductive switches, and toggle switches.

4. The transmitter of claim 3, wherein the zone display comprises either an LED display or an LCD display.

5. The transmitter of claim 4, wherein the LED display comprises a plurality of LEDs equal in number to the plurality of switches of the zone selector, such that each LED corresponds to a respective switch.

6. A system for wireless multi-zone independent control of a flash device for a camera, the system comprising:
the transmitter of claim 1; and
at least one receiver configured to receive the wireless transmission from the transmitter, the receiver including a zone selector including a switch, the zone selector being configured to receive a zone selection from a user via the switch.

7. A receiver for wireless multi-zone independent control of a flash device for a camera, the receiver comprising:
a microprocessor; and
a zone selector including a switch, the zone selector configured to receive a zone selection from a user via the switch, the zone selector configured to transmit the zone selection to the microprocessor.

8. The receiver of claim 7, wherein the switch comprises a multi-gear selection switch.

9. A transmitter used for flash device wireless multi-zone independent control comprising a microprocessing unit at a transmitter terminal, a test switch unit, an LED display unit, a focus and photographing control unit, a channel selection unit, a camera input unit and a wireless output unit at the transmitter terminal connected to the microprocessing unit as well as a camera output unit connected to the camera input unit, the transmitter also comprising a zone signal transmitting unit at the transmitter terminal connected to the microprocessing unit, wherein the zone signal transmitting unit at the transmitter terminal is connected with a zone selection unit at the transmitter terminal with multiple independent switch devices and a zone display unit at the transmitter terminal connected to the transmitter terminal.

10. The transmitter according to claim 9, wherein the zone selection unit at the transmitter terminal includes multiple independent switches which transmit unit input control signals to the zone signal transmitting unit at the transmitter terminal, thus driving the zone display unit at the transmitter terminal to indicate the selected zone and at the same time transmits the indicated zone information to the microprocessing unit which will output the corresponding one group or multiple groups of control codes through the wireless output unit.

11. The transmitter according to claim 10, wherein the switches include one or more of a touch switch, a self-lock switch, an inductive switch or a toggle switch.

12. The transmitter according to claim 11, wherein the zone display unit at the transmitter terminal is an LED display unit or an LCD display unit.

13. The transmitter according to claim 12, wherein the LED display unit quantity is the same as that of the switches and each LED display unit corresponds to each switch.

14. The transmitter according to claim 9, the transmitter in combination with a receiver used for flash device wireless multi-zone independent control thus forming a system, the receiver including a micro processing unit at a receiver terminal, a test switch unit, an LED display unit, a focus and photographing output unit, a channel selection unit, an output unit and a wireless input unit at the receiver terminal connected to the microprocessing unit as well as a focus and photographing switch control unit connected to focus and photographing output unit, the receiver also including a zone selection unit at the receiver terminal connected to the micro processing unit.

15. The transmitter according to claim 14, wherein the zone selection unit at the receiver terminal includes a multi-gear selection switch device.
